(19) United States
(12) Patent Application Publication
(10) Pub. No.: US 2014/0065447 A1
(43) Pub. Date: Mar. 6, 2014

(54) HYBRID CAPACITOR-BATTERY AND SUPERCAPACITOR WITH ACTIVE BI-FUNCTIONAL ELECTROLYTE

(71) Applicant: APPLIED NANOSTRUCTURED SOLUTIONS, LLC, (US)

(72) Inventors: Han LIU, Lutherville-Timonium, MD (US); Corey Adam Fleischer, Columbia, MD (US); William Patrick Burgess, Finksburg, MD (US); Lawrence P. Hetzel, Fallston, MD (US); Gregory F. Pensero, Abingdon, MD (US); Tushar K. Shah, Fulton, MD (US)

(73) Assignee: APPLIED NANOSTRUCTURED SOLUTIONS, LLC, Baltimore, MD (US)

(21) Appl. No.: 13/645,426

(22) Filed: Oct. 4, 2012

Related U.S. Application Data
(60) Provisional application No. 61/545,049, filed on Oct. 7, 2011.
(60) Provisional application No. 61/707,738, filed on Sep. 28, 2012.

(51) Int. Cl. H01M 12/00

(52) U.S. Cl. CPC H01M 12/005
USPC 429/7; 429/231.8; 429/212; 429/213; 429/224; 205/57; 427/122

(57) ABSTRACT

An electrode includes a substrate having a carbon nanostructure (CNS) disposed thereon and a coating including an active material conformally disposed about the carbon nanostructure and the substrate. The electrode is used in a hybrid capacitor-battery having a bifunctional electrolyte capable of energy storage.

### CROSS-REFERENCE TO RELATED APPLICATIONS

The present application claims the benefit of priority under 35 U.S.C. §119 from U.S. Provisional Patent Application Ser. No. 61/545,049 entitled “Hybrid Cap-Battery with Active Bi-Functional Electrolyte,” filed on Oct. 7, 2011, and U.S. Provisional Patent Application Ser. No. 61/707,738 entitled “Carbon Nanostructures and Method of Making the Same,” filed on Sep. 28, 2012, the disclosures of which are hereby incorporated by reference in their entirety for all purposes.

### FIELD OF THE INVENTION

The present invention relates to electrochemical devices, and more particularly, electrical devices capable of energy storage.

### BACKGROUND OF THE INVENTION

In conventional capacitors and batteries, the electrode is the active material. The electrolyte creates a continuous path for ion migrations. To increase the capacitance/capacity, the amount of electrode is increased proportionally. Since the electrode is usually highly porous to enhance ion transport, the amount of electrolyte also increases proportionally given the same porosity. The amount of electrolyte, however, does not contribute to an increase of capacity.

It would be beneficial to develop an energy storage device with an active electrolyte that can contribute to the overall capacity. Such an electrolyte can behave as a bi-functional element serving to conduct ions and react on the electrode surfaces to contribute to the overall energy storage. The present invention provides such an energy storage device and provides related advantages as well.

### SUMMARY OF THE INVENTION

In some aspects, embodiments disclosed herein relate to an energy storage device that employs compositions for the electrolyte and electrode material whereby the electrolyte can contribute to the overall energy storage, while the electrode maintains its role as the active material.

In some aspects, embodiments disclosed herein relate to an electrode comprising a substrate having a carbon nanostructure (CNS) disposed thereon, and a coating comprising an active material conformally disposed about the carbon nanostructure and the substrate.

In some aspects, embodiments disclosed herein relate to a hybrid capacitor-battery comprising an electrode comprising a substrate having a carbon nanostructure (CNS) disposed thereon and an optional coating comprising an active material conformally disposed about the carbon nanostructure and substrate, and a bifunctional electrolyte, wherein the bifunctional electrolyte is capable of energy storage.

In some aspects, embodiments disclosed herein relate to a method comprising synthesizing a carbon nanostructure (CNS) on a substrate to provide a CNS-laden substrate and conformally coating the CNS-laden substrate with an active material.

### BRIEF DESCRIPTION OF THE DRAWINGS

FIG. 1 shows an electrode comprising a substrate having a carbon nanostructure (CNS) disposed thereon, and a coating comprising an active material conformally disposed about the carbon nanostructure and the substrate, in accordance with one embodiment.

FIG. 2 shows a carbon nanostructure (CNS) or “flake” structure as a simplified rendering, in accordance with embodiments disclosed herein.

FIG. 3 shows a scanning electron micrograph (SEM) image of an authentic sample CNS structure, in accordance with embodiments disclosed herein.

FIG. 4 shows a flow diagram of a process for preparing CNS on a substrate indicating the ability to store the CNS on the substrate or isolate the CNS directly after synthesis.

FIG. 5 shows a catalyst having an anti-adhesion layer to facilitate CNS isolating from the substrate and/or catalyst, in accordance with embodiments disclosed herein.

FIG. 6 shows an exemplary generic process flow diagram for wet and dry removal of CNS as a flake product as well as optional post isolation processing, in accordance with embodiments disclosed herein.

FIG. 7 shows an exemplary process flow diagram for the removal of CNS from a substrate employing air nozzles and a cyclonic filter, in accordance with embodiments disclosed herein.

FIG. 8 shows a diagram of removal of a CNS network by shearing the bond between catalyst particles and the substrate in a CNS growth motif with predominant basal CNS growth, in accordance with embodiments disclosed herein.

FIG. 9 shows a diagram of removal of a CNS network by shearing the bond between catalyst particles and the CNS in a CNS growth motif with predominant basal CNS growth, in accordance with embodiments disclosed herein.

FIG. 10 shows a hybrid capacitor-battery comprising an electrode as shown in FIG. 1 and a bifunctional electrolyte, in accordance with one embodiment.

### DETAILED DESCRIPTION

The present invention is directed, in part, to an energy storage device that includes carbon nanostructure (CNS)-infused fiber material serving as an electrode and a bi-functional electrolyte that can conduct ions and react on the electrode surfaces to contribute to the overall energy storage. In particular embodiments, the CNS-infused fiber material is a carbon fiber material, although any fiber composition can be employed in the storage devices disclosed herein.

Electrodes are the primary active material in conventional energy storage devices such as capacitors and batteries. While the electrolyte serves as a liquid wire offering ion conductivity, it does not contribute to the overall energy storage. In a conventional system, the electrolyte should fill all pores of a porous electrode material to render the electrode material active. Electrodes are desirably highly porous to reduce ionic resistance and thus enhance power and efficiency. In principle, a highly active porous electrode material can offer high energy per unit weight. However, in conventional capacitors and batteries the advantage is significantly offset by the fact that the electrolyte needs to fill up the pores adding weight to the overall structure, without contributing to storage capacity. This issue has been addressed, in part, by an engineering solution: capacitors are placed in parallel to batteries to reduce the load during peak power. This solution, however, does not make use of the potential for converting the electrolyte from an inert liquid ion wire to an active component that contributes to overall capacity for energy storage, as provided by the energy storage devices of the present invention.

Among the many advantages of the present invention, the energy storage devices disclosed herein include an electrolyte that can significantly increase the energy storage density of the devices. During normal operation, the energy storage devices disclosed herein can behave like a battery. When pulse power is required, the devices can deliver high pulse current similar to that of a capacitor. Once the pulse load is removed, if there is still battery capacity left, the unit can self charge the capacitor without drawing power from external circuits. Compared to conventional “inactive” electrolytes, a bi-functional electrolyte, as disclosed herein, can be oxidized on the anode side and reduced on the cathode side. Cell level energy can be improved since the electrolyte is part of the active reaction and not simply serving as a “liquid wire”. Moreover, the liquid phase redox reaction of the bi-functional electrolyte is intrinsically faster than solid electrode reactions, due to significantly faster ion diffusion in liquids relative to solids. Thus, power density can be improved.

During charge/discharge cycles, the active species must diffuse to the electrode surface. After oxidization/reduction, the product species must diffuse back to the bulk electrolyte. Conventional activated carbon cannot satisfy the demand since it contains a large amount of internal pore surface with pore diameters in the nanometer range. This morphology creates a significant diffusion barrier and can lead to poor power capability and low current density. By contrast, electrodes employed in the present invention using CNS-infused carbon fibers have very high external surface area. Such high surface area is readily accessible to ions. Thus, the structure of the CNS-infused fiber allows high power density in conjunction with the bi-functional electrolyte, especially where the fiber material is a carbon fiber material.

Additionally, conventional foil based electrodes can only deform along one dimension, resulting in an ability to construct only simple shaped electrodes, such as cylinder/cones. Any doubly curved surface, such as a spherical shape, can lead to wrinkles/folds that compromise mechanical and electrical integrity. By contrast, where the CNS-infused carbon fiber is a fabric, the fabric can obviate such issues. Such CNS-infused carbon fiber fabric can create batteries and/or capacitors that conform to unique shapes.

Moreover, the CNS-infused carbon fiber has a higher weight normalized mechanical strength compared to metal foils employed as electrodes. Thus, structurally robust capacitors and batteries can be developed for applications that require multifunctional energy storage devices that can also act as structural elements.

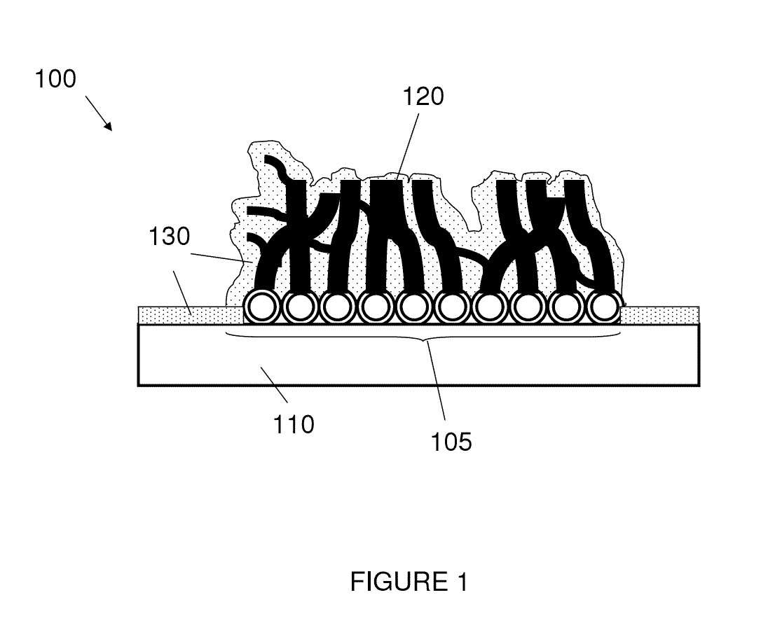

In some embodiments, the present invention provides an electrode comprising a substrate having a carbon nanostructure (CNS) disposed thereon and a coating comprising an active material conformally disposed about the carbon nanostructure and substrate. Referring now to FIG. 1, there is shown an electrode 100, in accordance with some embodiments. Electrode 100 includes substrate 110 upon which a carbon nanostructure (CNS) 120 is grown with the aid of nanoparticle catalysts 105. The resultant CNS-infused substrate can be conformally coated with an active material 130 about CNS 120 and substrate 110. In some embodiments, active material 130 is optional and may depend on, inter alia, the choice of electrolyte employed in conjunction with electrode 100. While FIG. 1 depicts the CNS 120 resulting from basal growth of the CNT web structure from nanoparticle catalysts 105, those skilled in the art will appreciate that the CNS growth can be effected with basal growth, tip growth, or combinations of the two growth modes. Additionally, in some embodiments, nanoparticle catalysts 105 may also reside within the middle of the structure of CNS 120.

While substrate 110 of the electrode can be of any conventional types, such as activated carbon, carbon blacks, conductive polymers or metal oxides, in some embodiments, it is desirable to employ CNS-infused fiber as substrate 110. Carbon nanostructures 120 may be directly grown on the fibers, as described in further detail below. The CNS forms a radial array structure around each fiber. The infusion process provides electric contacts between the CNS and the fibers. The CNS material can contribute between 1%-33% of the total mass of the electrode, in some embodiments. In some embodiments, more than 90% of the surface area is attributable to the CNS, with an overall surface area in a range from about 1 m²/g to about 1500 m²/g, in some embodiments, and from about 20 m²/g to about 200 m²/g, in other embodiments, including any values in between and fractions thereof.

In some embodiments, the substrate of the electrode need not be limited to carbon compositions and thus, the substrate can comprise one selected from the group consisting of glass, carbon, ceramic, metal, and an organic polymer. Any such composition may be suitable as a base material for the substrate so long as the requisite carbon nanostructure can be infused to the surface. Likewise, the electrode substrate need not be limited to simple fiber forms. In some embodiments, the substrate can comprise a form selected from the group consisting of a fiber, a tow, a woven or non-woven fabric, a foil, a ply, a chopped strand mat, and a felt. The ability to move away from simple linear fibers to complex fabric-type materials provides for the ability to address batteries with complex shapes and the ability to conform to complex surfaces. Nonetheless, in preferred embodiments, the substrate comprises a carbon fiber, and in particular, the substrate comprises a carbon fabric.

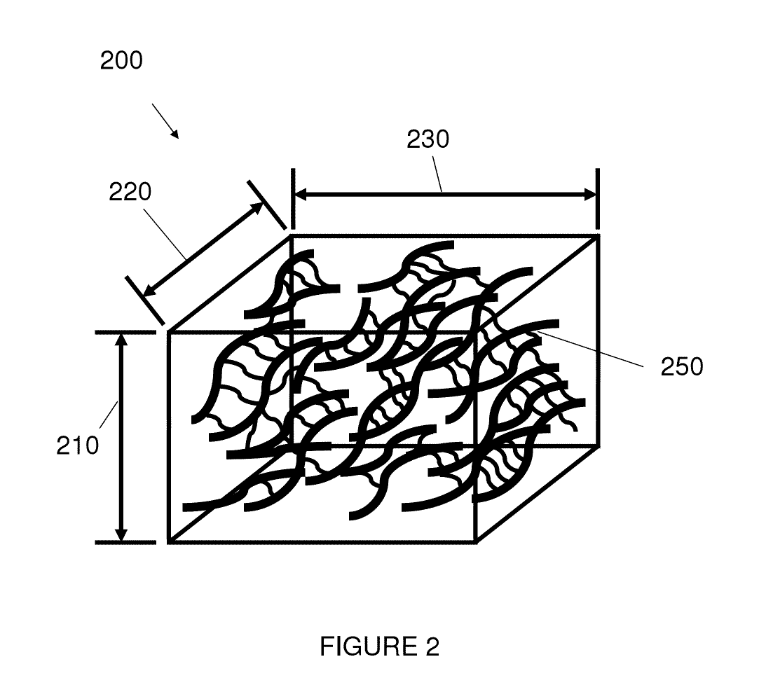

In some embodiments, the CNS is not bound to an electrode material and the CNS is itself a free-standing electrode. Referring to FIG. 2 there is shown a diagram of the CNS 200 as a flake-like microstructure, the flake being isolated after growth of CNS 200 on a suitable substrate and subsequently removed from the substrate. The basic flake can have a first dimension 210 that is in a range from about 1 nanometer (nm) to about 500 nm thick, including any value inbetween and fractions thereof. The basic flake can have a second dimension 220 that is in a range from about 1 micron to about 750 microns tall, including any value inbetween and fractions thereof. The basic flake dimensions can have a third dimension 230 that is only limited in size based on the length of a substrate on which CNS 200 is grown and can range from several microns up to many meters. For example, the process for growing CNS 200 on a substrate can be accomplished with a tow or roving of a fiber-based material. The process is continuous and the CNS can extend the entire length of a spool of fiber. Thus, by way of example, a third dimension can be in a range from about 1 meter (m) to about 10,000 m wide. Again, this dimension can be very long because it represents the dimension that runs along the axis of the substrate upon which CNS 200 is prepared and this can be accomplished on a continuously fed substrate such as a fiber tow or roving, a tape, sheet, or the like. Clearly, the third dimension can also be cut to any desired length including less than 1 meter. The CNS polymer-like structure is thus provided as a continuous layer on whatever substrate type upon which it is grown which, in turn, can provide materials of exceptionally high molecular weight.

CNS 200 comprises a webbed network of CNTs 250 in the form of a carbon nanopolymer which may have a molecular weight in a range from about 15,000 g/mol to about 150,000 g/mol, including all values inbetween and fractions thereof. The upper end of the molecular weight can be even higher, including 200,000 g/mol, 500,000 g/mol, and 1,000,000 g/mol. In some embodiments, the molecular weight may be a function of the predominant diameter and number of walls of CNTs within the carbon nanostructure web. The CNS structures disclosed herein can have a cross link density in a range from about 2 mol/cm³ to about 80 mol/cm³. The crosslinking density may be a function CNS growth density on the surface of the substrate as well as CNS growth conditions.

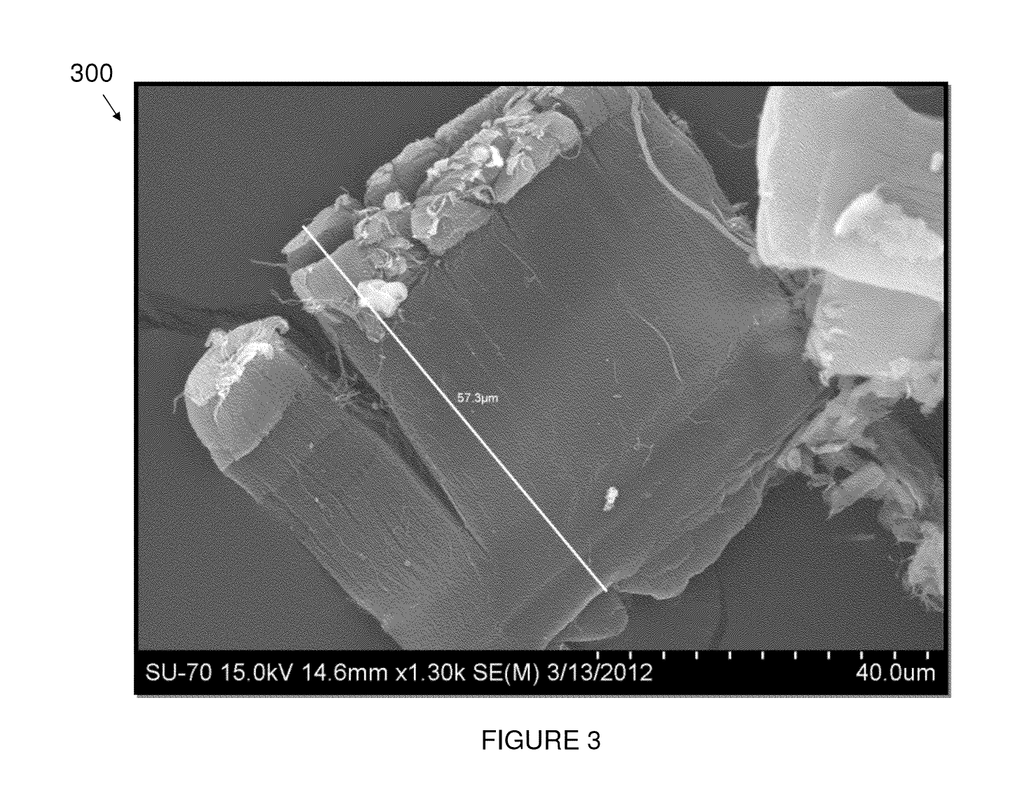

CNS 200 comprises a network of highly interdigitated, entangled, and cross-linked networks of carbon nanotubes (CNTs) which are grown as robust coatings on substrates such as composite fibers and can be extracted and isolated as a flake-like material as shown in the artistic rendering of FIG. 2 and the SEM image of an authentic sample of CNS 300 shown in FIG. 3. These CNS flakes exist as a three dimensional microstructure due to the entanglement and cross-linking of highly aligned CNTs. The aligned morphology is reflective of the synthesis having been performed on a substrate, i.e. the CNS grows perpendicularly to the substrate surface. Without being bound by theory, it has been postulated that the rapid rate of CNT synthesis, which may approach several microns per second, may contribute to the complex CNS morphology.

The CNS morphology can be accessed via CNT growth conditions, which are detailed herein further below. The density of the CNS flake product can be tightly modulated by the CNT growth conditions, including, for example, the concentration of the catalyst particles disposed on the substrate. Advantageously, the crosslinking does not require any post CNT modification reactions to effect crosslinking such as chemical etching and other chemical modifications which can erode the beneficial CNT properties. The CNS structure is believed to result from the rapid growth of the CNS on the substrate.

While a conventional CNT growth process for producing CNT forests typically takes several minutes per micron employing most growth techniques, the CNS processes disclosed herein can exhibit a nominal CNT growth rate on the order of microns per second in a continuous in situ process. As a result, the structure is more defective, containing highly entangled, branched, and cross-linked CNTs. While the focus of the skilled artisan has been mainly on high purity growth which requires higher temperatures and longer synthesis times, the in situ, continuous growth process for CNS growth synthesizes CNTs at such a rapid rate that it creates a branched and crosslinked CNT network that is CNS. Moreover, the ability to grow the CNS structure continuously on a substrate provides access to quantities of CNS flake that are difficult to access via conventional CNT preparations. The preparation of the CNS on a substrate helps to avoid CNT bundling which is observed when working with individualized CNTs. In some embodiments, bundling can be controlled via alignment of growth and size (length) of the CNS on the substrate. The free CNS can be manipulated into any type of shaped free-standing electrode, in accordance with embodiments disclosed herein.

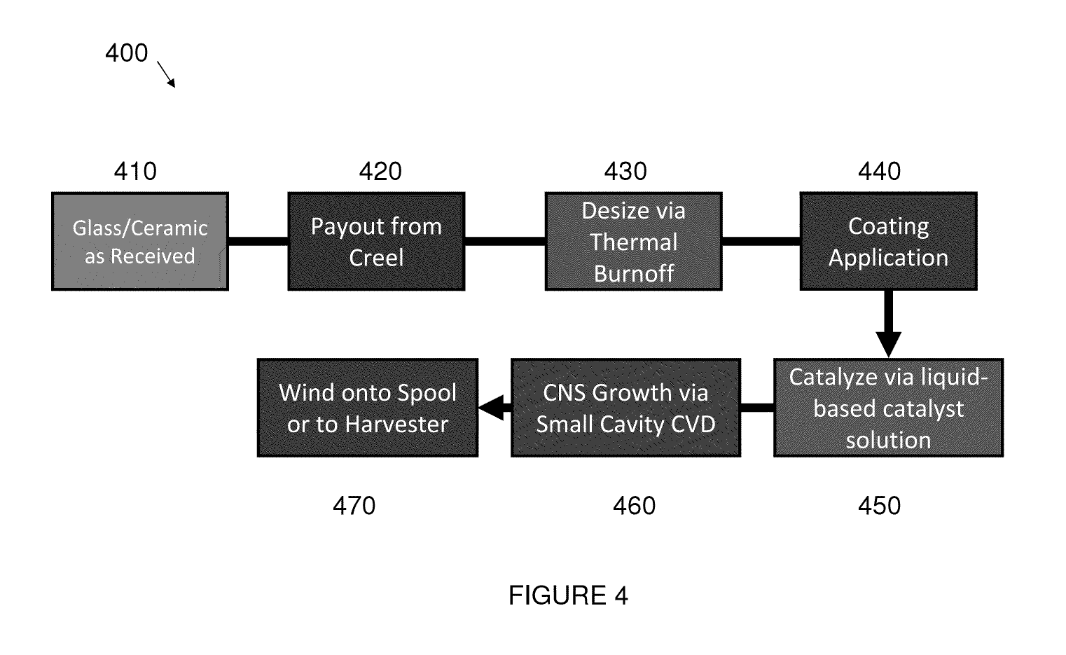

FIG. 4 shows a flow diagram of a CNS growth process 400 which employs an exemplary glass or ceramic substrate 410. It is to be understood that the choice of glass or ceramic substrates is merely exemplary and that the substrate could also be metal, an organic polymer, such as an aramid, basalt fiber, or carbon, for example. The CNS growth process may also employ substrates in a variety of forms such as fibers, tows, yarns, and woven and non-woven fabrics. For convenience in continuous synthesis fiber type tows and yarns are particularly convenient.

As indicated in FIG. 4, such a fiber can be meted out in step 420 with the aid of a payout creel and delivered to an optional desizing station. The desizing step 430 can be skipped if the sizing employed assists in reduced catalyst/CNS to fiber adhesion which can aid in later isolation. Numerous sizing compositions associated with fiber substrates can contain binders and coupling agents primarily providing anti-abrasive effects, but typically don't exhibit exceptional adhesion to fiber surface. For this reason, it may be beneficial to skip desizing. In some embodiments, the process shown in FIG. 4 can also employ an additional coating application at step 440, such as colloidal ceramic, glass, silane, or siloxane to reduce catalyst and/or CNS structure adhesion to the substrate. This may aid in the removal of the CNS from the substrate. In some embodiments, a combination of sizing material and additional coating may provide the requisite anti-adhesive properties to facilitate CNS isolation. In some embodiments, the sizing material alone provides the requisite anti-adhesive properties to facilitate CNS isolation. In some embodiments, the additional coating application alone provides the requisite anti-adhesive properties to facilitate CNS isolation. In yet still further embodiments, neither sizing agent nor additional coating provides the requisite anti-adhesive properties to facilitate CNS isolation, instead the reduced adhesion may be provided by judicious choice of CNT growth catalyst nanoparticle. In some embodiments, in the catalyst application step where a catalyst is specifically chosen for poor adhesive characteristics.

Referring again to FIG. 4, after any optional desizing 430 and optional coating 440, catalyst is applied to the substrate in step 450 and CNS growth is effected in a small cavity CVD process in step 460. The nascent CNS-laden substrate can be wound for storage or immediately taken into CNS isolation processes as indicated in step 470. In some embodiments, the CNS-laden substrate can be formed into an electrode material directly without CNS removal. In some such embodiments, the substrate itself may be the electrode material. In other embodiments, the CNS is removed and formed into the electrode. In some embodiments, the substrate is a pre-designated shape such that synthesis on the substrate and optional harvesting provide either a CNS-laden shaped electrode or a pre-shaped free-standing CNS structure.

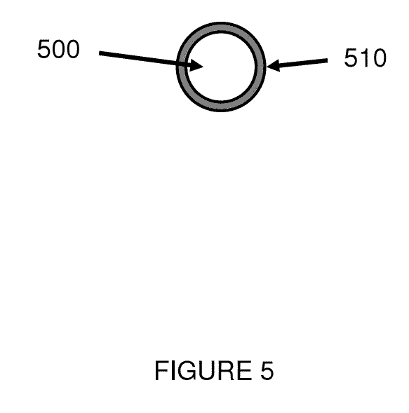

In some embodiments, one mode for catalyst application is through particle adsorption with catalyst application including, for example liquid or colloidal precursor-based application. Suitable catalysts materials can include any d-block transition metal or d-block transition metal salt. In some embodiments, metal salts can be applied without thermal treatments. Referring to FIG. 5, in some such embodiments, a catalyst 500 may be provided with an anti-adhesive layer 510. In some embodiments, colloidal particle solutions can be used in which an exterior layer about the catalyst nanoparticle which promotes substrate to particle adhesion but prevents CNS to particle adhesion.

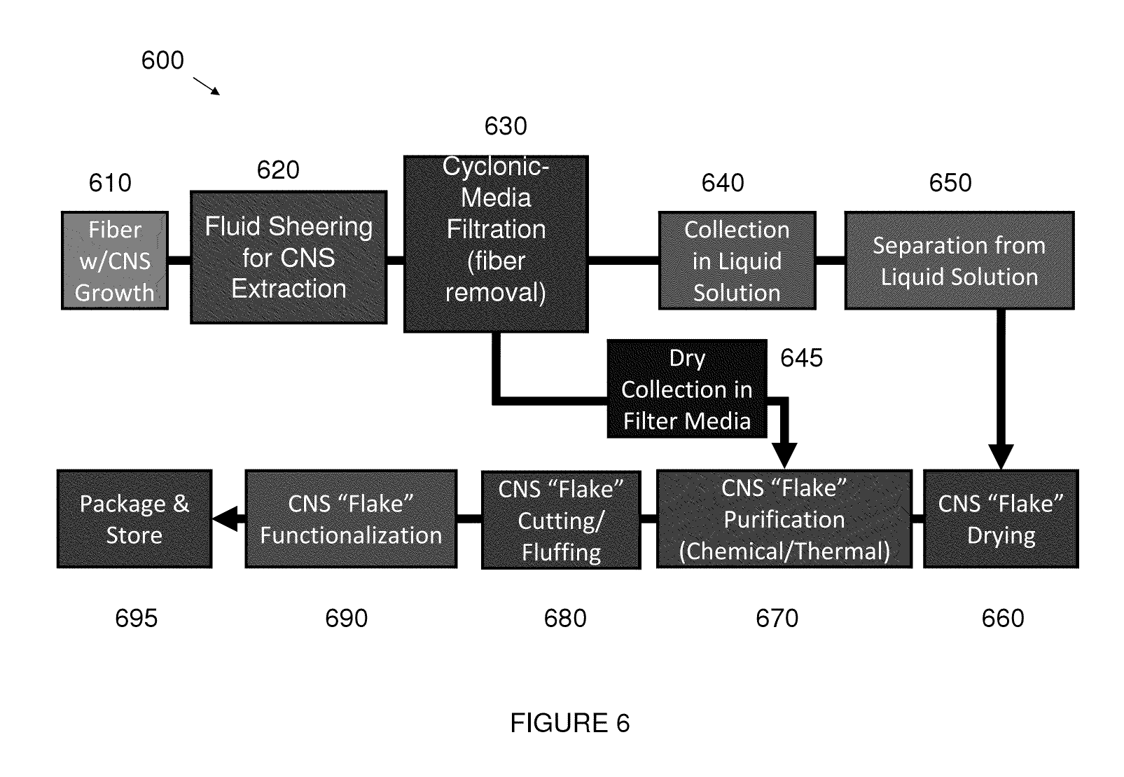

Referring now to FIG. 6 there is shown a flow diagram of an exemplary CNS isolation process 600. Fluid shearing step 630 with gas or liquid may be employed for CNS extraction. The removed CNS may be subjected to cyclonic/media filtration at step 620 to remove fiber (or other substrate). In the case of a gas used for shearing, the CNS can be collected in step 645 in dry form on a filter. The resultant dry flake material can be subjected to any optional further chemical or thermal purification 670. In a process employing liquid shearing 630, the liquid can be collected in step 640 and the CNS separated from the solution in step 650. The separated CNS can then be dried in step 660 and purified in step 670 as above. Optionally, the CNS flake can be fluffed and/or cut in step 680. Further optionally, the CNS flake may be functionalized in step 690. After isolating CNS flake and any optional post-processing it is ready for packaging in step 695 for storage or it can be carried on to form a free standing CNS electrode.

The CNS flake can undergo further processing such as cutting/fluffing in step 680 either via mechanical ball milling or chemical processes. In some embodiments, the CNS flake can also be modified in step 690 in any manner in which CNTs are normally modified, including, for example, plasma processing, chemical etching, and the like. Such post processing modifications may alter the CNS network by providing chemical functional group handles for further modifications.

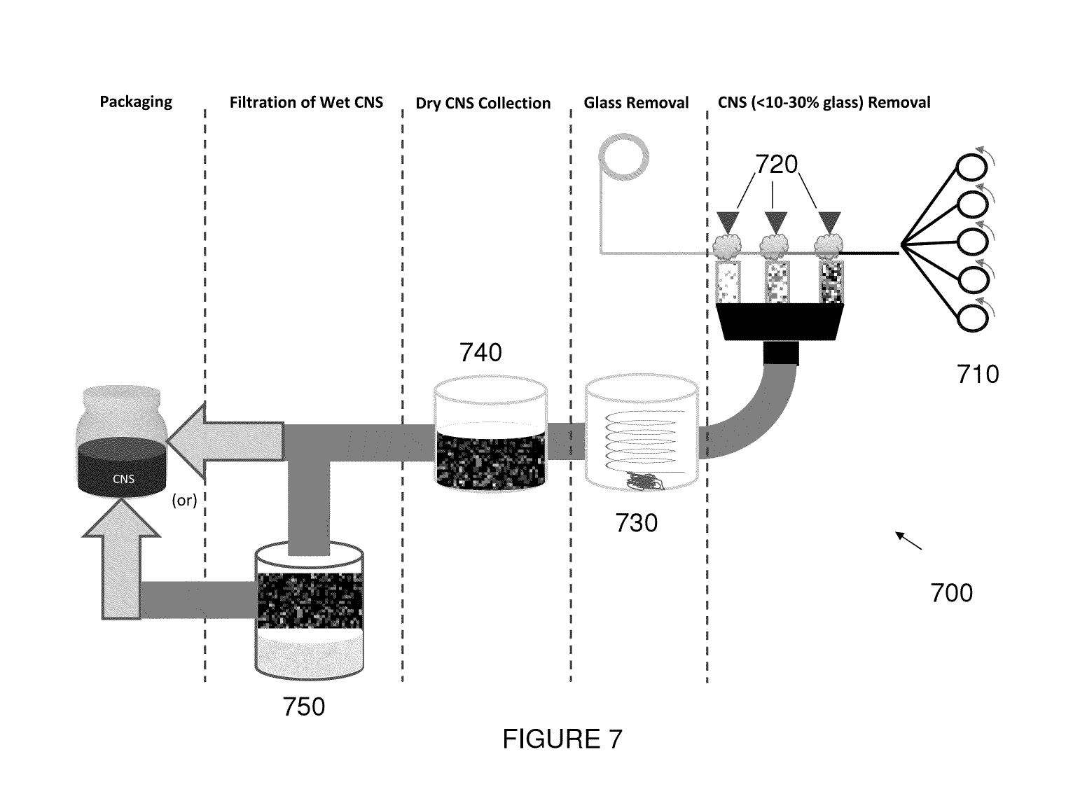

Referring now to FIG. 7, there is shown a CNS isolation process 700 in accordance with further embodiments. As indicated in FIG. 7, a single or multiple spools 710 of CNS-laden fiber-type substrates may be fed to a removal chamber using payout and take-up system. CNS isolation may be achieved via a single or several pressurized air source tools 720 such as an air knife or air nozzle. Such air tools 720 may be placed perpendicular to the spool and the air directed on to the substrate carrying the CNS. In some embodiments, the air tool can be stationary, while in other embodiments, the air tool can be movable. In some embodiments, where the air tool is movable, it can be configured to be oscillating along the surface of the CNS-laden fiber to improve extraction efficiency. Moreover, upon air impact fiber tows and other bundled type fiber substrates may be spread exposing the surface of the CNS-laden substrate improving removal of the CNS, while advantageously avoiding mechanical contact. In some embodiments, the integrity of the substrate may be sufficient to recycle back to through the CNS process in a continuous cycle of synthesis and CNS removal.

In some embodiments, the integrity of the substrate may be compromised and fragmented substrate can be removed, for example, with the aid of a cyclonic filter 730, as indicated in FIG. 7. Thus, using single or multiple vacuum and cyclonic technology in series or parallel, or a combination of series and parallel, free floating CNS can be separated from unintentionally removed substrate. Such techniques may employ multiple stages of rates/filter media to selectively capture fiber material while letting CNS pass to a CNS collection vessel. The resultant CNS can be either collected dry 740 or wet 750 as a sludge as shown in FIG. 7. In some embodiments, the CNS can be removed directly from the vacuum container and packed into a shippable container. In some embodiments, the CNS as a wet sludge may be delivered to a mold for fabricating an electrode material and the solvent subsequently removed to provide a free-standing CNS electrode.

In some embodiments, where wet processing is employed, the CNS can be mixed with about 1% to about 40% solvent in water and run through a filter to separate the CNS from the fluid. The resultant separated CNS material can be dried and packed or stored “wet” as a dispersion. It has been observed that unlike individualized CNT solutions, the CNS structure advantageously forms stable dispersions. In some embodiments, this may be achieved in the absence of stabilizing surfactants, even with water as solvent. Suitable solvents in connection with wet processing include, but are not limited to, isopropanol (IPA), ethanol, methanol, and water.

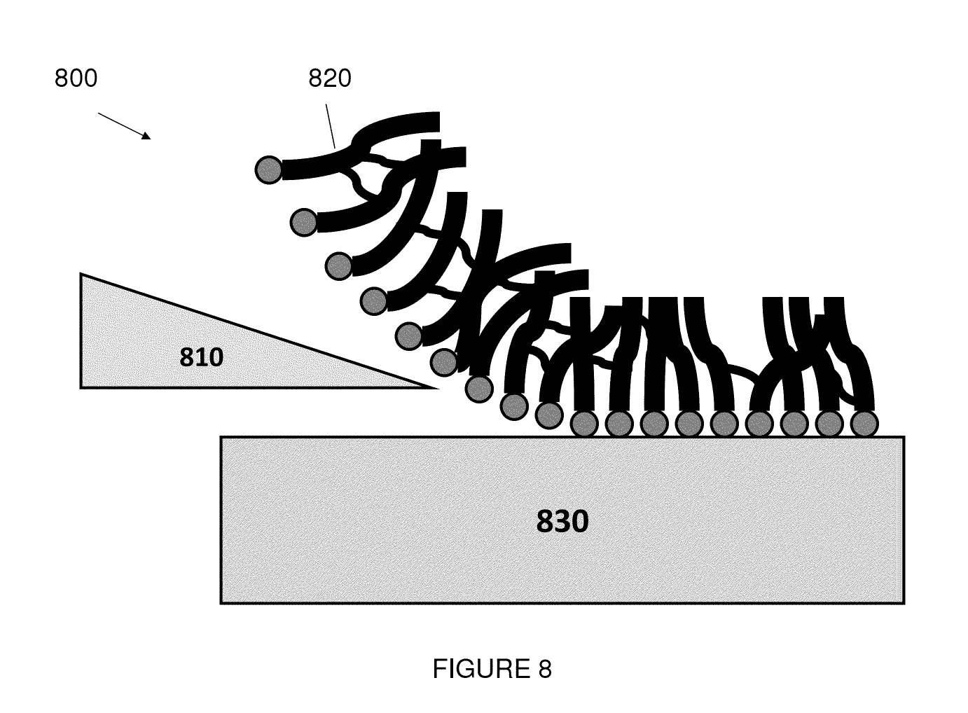

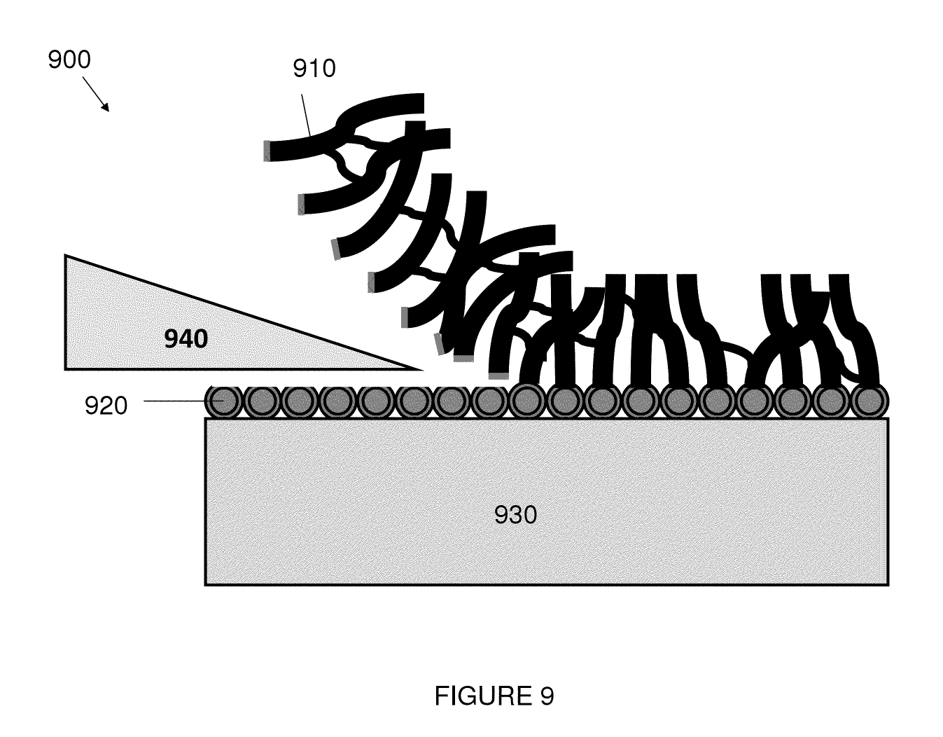

Referring now to FIG. 8, CNS extraction 800 can employ mechanical shearing forces 810 to remove the both the CNS and nanoparticle catalyst as a monolithic entity 820 from substrate 830. In some such embodiments, sizing chemistry and/or additional coatings can be employed to prevent particle to fiber adhesion allowing for the CNS/catalyst structure to shear via gas or liquid methods. In some embodiments, the nanoparticle catalyst can be a transition metal salt with a counter-anion selected to etch substrate 830 to facilitate CNS/catalyst 820 removal. In some embodiments, a chemical etch can be employed independently from the catalyst choice. For example, when employing a glass substrate, a hydrogen fluoride etch may be used to weaken the CNS and/or nanoparticle catalyst adhesion to the substrate. Alternatively, as shown in FIG. 9, CNS 910 extraction absent the nanoparticle catalyst 920 may be effected by use of an implanted nanoparticle catalyst on the fiber substrate 930, followed by shear removal 940 of the CNS from the nanoparticles. In some such embodiments, layered catalyst 920 may promote adhesion to the surface of fiber substrate 930, while CNS 910 to nanoparticle catalyst 920 adhesion is reduced.

Although FIGS. 8 and 9 indicate CNS growth in a motif involving basal catalyst growth, the skilled artisan will recognize that direct CNS fiber contact may also be achieved such that the catalyst resides distal to the substrate on the surface of the CNS structure (tip growth) or somewhere between tip and basal growth. In some embodiments, predominant basal growth is selected to aid in CNS removal from the substrate.

The carbon nanostructures disclosed herein comprise carbon nanotubes (CNTs) in a network having a complex morphology. Without being bound by theory, it has been indicated that this complex morphology may be the result of the preparation of the CNS network on a substrate under CNT growth conditions at a rapid rate on the order of several microns per second. This rapid CNT growth rate coupled with the close proximity of the nascent CNTs may provide the observed branching, crosslinking, and shared wall motifs. In the discussion that follows, access to CNS bound to a fiber substrate is described. For simplicity, the discussion will may refer to the CNS disposed on the substrate interchangeably with CNTs because CNTs comprise a major structural component of the CNS network.

Suitable substrates for forming CNS include fibers in the form of rovings, tows, and the like, tapes, sheets and even three dimensional forms which can be used to provide a shaped CNS electrodes. The processes described herein allow for the continuous production of carbon nanotubes that make up the CNS network having uniform length and distribution along spoolable lengths of tow, tapes, fabrics and other 3D woven structures.

In some embodiments, any of the aforementioned electrodes, either CNS bound to electrode material or free-standing CNS electrode, may be coated with an active material comprising one selected from the group consisting of a metal oxide, a metal phosphate, a conducting polymer, and a semiconductor. For example, the active material may comprise one selected from the group consisting of lithium oxide, lithium phosphate, oxides of manganese, oxides of ruthenium, polypyrrole, and silicon. Where inorganic electrolytes are included, the optional active coating may be present. Where organic electrolytes are employed, the optional active coating may be omitted. In some embodiments, an active material such as lithium metal oxide, lithium metal phosphate, conductive polymers (polypyrrole), metal oxide, such as vanadium (V) oxide, nickel oxide, and high capacity semiconductors (silicon, manganese oxide (MnOx), RuOx) can be directly deposited onto the CNS at the nanoscale to form a core/shell structure.

In some embodiments, the present invention provides a method comprising synthesizing a carbon nanostructure (CNS) on a substrate to provide a CNS-laden substrate and conformally coating the CNS-laden substrate with an active material. The active material, can be coated conformally onto each individual CNS as well as the substrate in the void portions where the CNS does not completely cover the substrate. The coating methods for manufacturing this structure include, but not limited to, chemical vapor deposition, physical vapor deposition, electrochemical deposition, solution dipping or solution spraying, for example. In particular embodiments, the active material comprises one selected from the group consisting of lithium oxide, lithium phosphate, oxides of manganese, oxides of ruthenium, polypyrrole, and silicon.

In some embodiments, methods presented herein can accommodate substrates in a form selected from the group consisting of a fiber, a tow, a woven or non-woven fabric, a foil, a ply, a chopped strand mat, and a felt. For example, CNS synthesis can be carried out directly on tows, fabrics and similar higher order substrates. In some embodiments, the CNS synthesis can be carried out on fiber and the CNS-laden fiber subsequently formed into fabrics and other higher order structures.

During the coating process, the radial array structure of the CNS is preserved. Thus, the continuous electron pathways are maintained. The nanoscale coating is sufficiently thin that the ion diffusion pathway is very short. In some embodiments, the coating thickness can be in a range from about 5 angstroms to about 10 microns. Since the coating is directly on CNS, electrons can be readily carried to the outer circuits, leading to high electrode conductivity. With such a structure, both ions and the electrons have direct/continuous access to the active material. Consequently, this structure can be referred as bi-continuous structure.

In some embodiments, electrodes disclosed herein above may be used in a hybrid capacitor-battery. In some such embodiments, the hybrid capacitor-battery includes an electrode comprising a substrate having a carbon nanostructure (CNS) disposed thereon; and an optional coating comprising an active material conformally disposed about the carbon nanostructure and substrate and a bifunctional electrolyte, wherein the bifunctional electrolyte is capable of energy storage. As used herein a “bifunctional electrolyte” means that the electrolytes serves not only as a liquid wire, but also has the ability to provide energy storage by means of chemical potential reactivity. The hybrid structure may be contained in a cell with the electrolyte in a typical solution such as water.

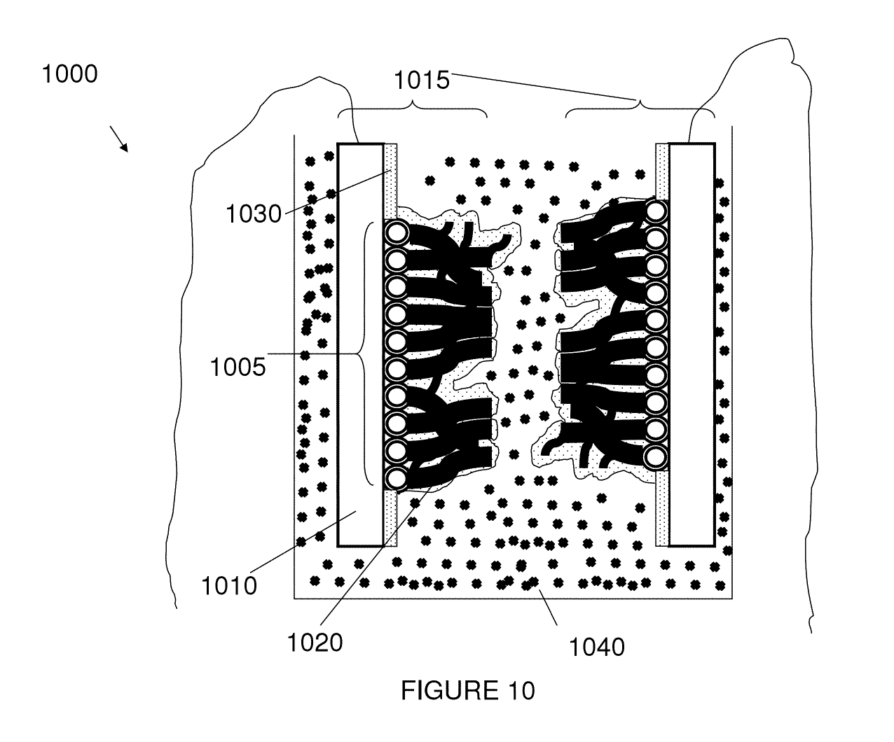

Referring now to FIG. 10, there is shown a hybrid capacitor battery 1000 in accordance with one embodiment. Hybrid capacitor battery 1000 includes an electrode 1015, as described herein above comprising a substrate 1010 with CNS 1020 infused thereon, CNS 1020 network having been grown on substrate 1010 via nanoparticle catalysts 1005. Further as described above, when employing an electrolyte 1040 that is an inorganic metal, optional active material 1030 may be used as a conformal coating about substrate 1010 and CNS 1020. Organic electrolytes may omit the use of active material 1030. Electrode 1015 may be provided as an anode, cathode, or both (as shown in FIG. 2). In some embodiments, electrolyte 1040 is selected to have energy storage capacity in the form of a chemical redox reaction. As such, both electrode 1015 and electrolyte 1040 can work together to enhance energy storage capacity.

In some embodiments, the hybrid capacitor-battery may comprise an electrode substrate that comprises one selected from the group consisting of glass, carbon, ceramic, metal, and an organic polymer, as described herein above, in a form selected from the group consisting of a fiber, a tow, a woven or non-woven fabric, a foil, a ply, a chopped strand mat, and a felt. In particular embodiments, the electrode substrate comprises a carbon fiber, and more particularly the substrate comprises a carbon fabric.

In a hybrid capacitor-battery the active material coating the electrode may comprise one selected from the group consisting of a metal oxide, a metal phosphate, a conducting polymer, and a semiconductor. In particular the active material comprises one selected from the group consisting of lithium oxide, lithium phosphate, oxides of manganese, oxides of ruthenium, polypyrrole, and silicon.

In some embodiments, the hybrid capacitor-battery may include the optional coating when the bifunctional electrolyte comprises inorganic ions, such as vanadium ions. In some embodiments the bi-functional electrolyte is selected to have a redox reaction at the operating potential, such as vanadium based system V²⁺/V³⁺ (anode side)-V⁴⁺/V⁵⁺ (cathode side). Other redox pairs include, without limitation, Zn (anode)-bromine (cathode), and iron (anode)-chromium (cathode).

In some embodiments, the hybrid capacitor-battery may omit the optional coating as would be the case when the bifunctional electrolyte comprises an organic electrolyte. Suitable organic electrolytes include, without limitation, include but are not limited to tetraethylammonium tetrafluoroborate/propylene carbonate (TEABF₄/PC), TEABF₄ dissolved in acetonitrile, and lithium hexafluorophosphate dissolved in ethylene carbonate/propylene carbonate or ethylene carbonate/dimethyl carbonate.

Energy storage devices of the invention can be provided from small coin cell capacitors, batteries, to large scale energy storage devices. The use of CNS-infused fibers prepared by the methods described below are amenable to substantial scale up.

The following description is provided as guidance to the skilled artisan for producing carbon nanostructures (CNS) infused on carbon fiber for use as electrodes in energy storage devices of the present invention. It will be recognized by those skilled in the art, that embodiments describing the preparation of carbon nanostructures on carbon fiber to make an electrode component in energy storage devices is merely exemplary. For example, similar electrode materials bearing carbon nanostructures can be prepared on other fiber materials, such as metal fibers, by similar methods.

The present disclosure is directed, in part, to carbon fiber materials bearing carbon nanostructures (CNS) disposed thereon, which construct functions in an electrode role in energy storage devices of the invention. In some embodiments, the carbon nanostructures comprise carbon nanotubes (CNTs) in a network having a complex morphology as described herein. For simplicity, the forgoing discussion will simply refer to the CNS disposed on the carbon fiber materials as CNTs, because CNTs comprise a major structural component of the network. It should be understood that reference to CNT is intended to mean the CNT array that has the CNS morphology of highly branched, interdigitated, crosslinked, and shared-wall CNTs.

CNTs infused on a carbon fiber material can alter various properties of the carbon fiber material, such as thermal and/or electrical conductivity, and/or tensile strength, for example. A CNS prepared on a carbon fiber provides an example of embodiments of a substrate bearing a CNS structure. It will be understood that other substrates, including other fiber types, such as glass, ceramic, aramid, and metal fibers can also be used a substrate. Moreover, the substrate need not be in fiber form. However, as explained below, preparation of fiber type substrates provide facile scalability to the processing. The processes employed to make CNT-infused carbon fiber materials can provide CNTs with substantially uniform length and distribution to impart their useful properties uniformly over the carbon fiber material that is being modified. Furthermore, the processes disclosed herein are suitable for the generation of CNT-infused carbon fiber materials of spoolable dimensions.

The processes disclosed herein can be applied to carbon fiber materials generated de novo before, or in lieu of, application of a typical sizing solution to the carbon fiber material. Alternatively, the processes disclosed herein can utilize a commercial carbon fiber material, for example, a carbon tow, that already has a sizing applied to its surface. In such embodiments, the sizing can be removed to provide a direct interface between the carbon fiber material and the synthesized CNTs, although a barrier coating and/or transition metal particle can serve as an intermediate layer providing indirect infusion, as explained further below. After CNT synthesis further sizing agents can be applied to the carbon fiber material as desired.

The processes described herein allow for the continuous production of carbon nanotubes of uniform length and distribution along spoolable lengths of tow, tapes, fabrics and other 3D woven structures. While various mats, woven and non-woven fabrics and the like can be functionalized by processes of the invention, it is also possible to generate such higher ordered structures from the parent tow, yarn or the like after CNT functionalization of these parent materials. For example, a CNT-infused woven fabric can be generated from a CNT-infused carbon fiber tow.

As used herein the term “carbon fiber material” refers to any material which has carbon fiber as its elementary structural component. The term encompasses fibers, filaments, yarns, tows, tapes, woven and non-woven fabrics, plies, mats, and the like.

As used herein the term “spoolable dimensions” refers to carbon fiber materials having at least one dimension that is not limited in length, allowing for the material to be stored on a spool or mandrel. Carbon fiber materials of “spoolable dimensions” have at least one dimension that indicates the use of either batch or continuous processing for CNT infusion as described herein. One carbon fiber material of spoolable dimensions that is commercially available is exemplified by AS4 12 k carbon fiber tow with a tex value of 800 (1 tex=1 g/1,000 m) or 620 yard/lb (Grafil, Inc., Sacramento, Calif.). Commercial carbon fiber tow, in particular, can be obtained in 5, 10, 20, 50, and 100 lb. (for spools having high weight, usually a 3 k/12K tow) spools, for example, although larger spools may require special order. Processes of the invention operate readily with 5 to 20 lb. spools, although larger spools are usable. Moreover, a pre-process operation can be incorporated that divides very large spoolable lengths, for example 100 lb. or more, into easy to handle dimensions, such as two 50 lb spools.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or open-ended. CNTs include those that encapsulate other materials. CNTs appear in branched networks, entangled networks, and combinations thereof. The CNTs also exhibit cross-linking. As used herein, the complex web-like morphology is referred to herein as a “carbon nanostructure,” or “CNS.” Thus, as used herein, “carbon nanostructure is distinct from arrays of individual carbon nanotubes.

As used herein “uniform in length” refers to length of CNTs grown in a reactor. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length.

As used herein “uniform in distribution” refers to the consistency of density of CNTs on a carbon fiber material. “Uniform distribution” means that the CNTs have a density on the carbon fiber material with tolerances of plus or minus about 10% coverage defined as the percentage of the surface area of the fiber covered by CNTs. This is equivalent to ±1500 CNTs/μηι² for an 8 nm diameter CNT with 5 walls. Such a figure assumes the space inside the CNTs as fillable.

As used herein, the term “infused” means bonded and “infusion” means the process of bonding. Such bonding can involve direct covalent bonding, ionic bonding, pi-pi, and/or van der Waals force-mediated physisorption. For example, in some embodiments, the CNTs can be directly bonded to the carbon fiber material. Bonding can be indirect, such as the CNT infusion to the carbon fiber material via a barrier coating and/or an intervening transition metal nanoparticle disposed between the CNTs and carbon fiber material. In the CNT-infused carbon fiber materials disclosed herein, the carbon nanotubes can be “infused” to the carbon fiber material directly or indirectly as described above. The particular manner in which a CNT is “infused” to a carbon fiber material is referred to as a “bonding motif.” The infused CNTs can also be branched and/or entangled.

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, serve as catalysts for CNT growth on the carbon fiber materials.

As used herein, the term “sizing agent,” “fiber sizing agent,” or just “sizing,” refers collectively to materials used in the manufacture of carbon fibers as a coating to protect the integrity of carbon fibers, provide enhanced interfacial interactions between a carbon fiber and a matrix material in a composite, and/or alter and/or enhance particular physical properties of a carbon fiber. In some embodiments, CNTs infused to carbon fiber materials behave as a sizing agent.

As used herein, the term “material residence time” refers to the amount of time a discrete point along a fiber material of spoolable dimensions is exposed to CNT growth conditions during the CNT infusion processes described herein. This definition includes the residence time when employing multiple CNT growth chambers.

As used herein, the term “linespeed” refers to the speed at which a fiber material of spoolable dimensions can be fed through the CNT infusion processes described herein, where linespeed is a velocity determined by dividing CNT chamber(s) length by the material residence time.

In some embodiments, the present invention provides a composition useable as an electrode in an energy storage device that includes a carbon nanotube (CNT)-infused carbon fiber material. The CNT-infused fiber material includes a fiber material of spoolable dimensions, a barrier coating conformally disposed about the fiber material, and carbon nanotubes (CNTs) infused to the fiber material. The infusion of CNTs to the fiber material can include a bonding motif of direct bonding of individual CNTs to the carbon fiber material or indirect bonding via a transition metal NP, barrier coating, or both. In particular embodiments, the fiber material is a carbon fiber material.

Without being bound by theory, transition metal NPs, which serve as a CNT-forming catalyst, can catalyze CNT growth by forming a CNT growth seed structure. In one embodiment, the CNT-forming catalyst can remain at the base of the carbon fiber material, locked by the barrier coating, and infused to the surface of the carbon fiber material. In such a case, the seed structure initially formed by the transition metal nanoparticle catalyst is sufficient for continued non-catalyzed seeded CNT growth without allowing the catalyst to move along the leading edge of CNT growth, as often observed in the art. In such a case, the NP serves as a point of attachment for the CNT to the carbon fiber material. The presence of the barrier coating can also lead to further indirect bonding motifs. For example, the CNT forming catalyst can be locked into the barrier coating, as described above, but not in surface contact with carbon fiber material. In such a case a stacked structure with the barrier coating disposed between the CNT forming catalyst and carbon fiber material results. In either case, the CNTs formed are infused to the carbon fiber material. In some embodiments, some barrier coatings will still allow the CNT growth catalyst to follow the leading edge of the growing nanotube. In such cases, this can result in direct bonding of the CNTs to the carbon fiber material or, optionally, to the barrier coating. Regardless of the nature of the actual bonding motif formed between the carbon nanotubes and the carbon fiber material, the infused CNT is robust and allows the CNT-infused carbon fiber material to exhibit carbon nanotube properties and/or characteristics.

Again, without being bound by theory, when growing CNTs on carbon fiber materials, the elevated temperatures and/or any residual oxygen and/or moisture that can be present in the reaction chamber can damage the carbon fiber material. Moreover, the carbon fiber material itself can be damaged by reaction with the CNT-forming catalyst itself. That is, the carbon fiber material can behave as a carbon feedstock to the catalyst at the reaction temperatures employed for CNT synthesis. Such excess carbon can disturb the controlled introduction of the carbon feedstock gas and can even serve to poison the catalyst by overloading it with carbon. The barrier coating employed in the invention is designed to facilitate CNT synthesis on carbon fiber materials.

Without being bound by theory, the coating can provide a thermal barrier to heat degradation and/or can be a physical barrier preventing exposure of the carbon fiber material to the environment at the elevated temperatures. Alternatively or additionally, it can minimize the surface area contact between the CNT-forming catalyst and the carbon fiber material and/or it can mitigate the exposure of the carbon fiber material to the CNT-forming catalyst at CNT growth temperatures.

Compositions having CNT-infused carbon fiber materials are provided in which the CNTs are substantially uniform in length. In the continuous process described herein, the residence time of the carbon fiber material in a CNT growth chamber can be modulated to control CNT growth and ultimately, CNT length. This provides a means to control specific properties of the CNTs grown. CNT length can also be controlled through modulation of the carbon feedstock and carrier gas flow rates and reaction temperature. Additional control of the CNT properties can be obtained by controlling, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNT-infused carbon fiber material with uniformly distributed CNTs on carbon fiber materials while avoiding bundling and/or aggregation of the CNTs that can occur in processes in which pre-formed CNTs are suspended or dispersed in a solvent solution and applied by hand to the carbon fiber material. Such aggregated CNTs tend to adhere weakly to a carbon fiber material and the characteristic CNT properties are weakly expressed, if at all. In some embodiments, the maximum distribution density, expressed as percent coverage, that is, the surface area of fiber covered, can be as high as about 55% assuming about 8 nm diameter CNTs with 5 walls. This coverage is calculated by considering the space inside the CNTs as being “fillable” space. Various distribution/density values can be achieved by varying catalyst dispersion on the surface as well as controlling gas composition and process speed. Typically for a given set of parameters, a percent coverage within about 10% can be achieved across a fiber surface. Higher density and shorter CNTs are useful for improving mechanical properties, while longer CNTs with lower density are useful for improving thermal and electrical properties, although increased density is still favorable. A lower density can result when longer CNTs are grown. This can be the result of the higher temperatures and more rapid growth causing lower catalyst particle yields.

The compositions of the invention having CNT-infused carbon fiber materials can include a carbon fiber material such as a carbon filament, a carbon fiber yarn, a carbon fiber tow, a carbon tape, a carbon fiber-braid, a woven carbon fabric, a non-woven carbon fiber mat, a carbon fiber ply, and other 3D woven structures. Carbon filaments include high aspect ratio carbon fibers having diameters ranging in size from between about 1 micron to about 100 microns. Carbon fiber tows are generally compactly associated bundles of filaments and are usually twisted together to give yarns.

Yarns include closely associated bundles of twisted filaments. Each filament diameter in a yarn is relatively uniform. Yarns have varying weights described by their ‘tex,’ expressed as weight in grams of 1000 linear meters, or denier, expressed as weight in pounds of 10,000 yards, with a typical tex range usually being between about 200 tex to about 2000 tex.

Tows include loosely associated bundles of untwisted filaments. As in yarns, filament diameter in a tow is generally uniform. Tows also have varying weights and the tex range is usually between 200 tex and 2000 tex. They are frequently characterized by the number of thousands of filaments in the tow, for example 12K tow, 24K tow, 48K tow, and the like.

Carbon tapes are materials that can be assembled as weaves or can represent non-woven flattened tows. Carbon tapes can vary in width and are generally two-sided structures similar to ribbon. Processes of the present invention are compatible with CNT infusion on one or both sides of a tape. CNT-infused tapes can resemble a “carpet” or “forest” on a flat substrate surface. Again, processes of the invention can be performed in a continuous mode to functionalize spools of tape.

Carbon fiber-braids represent rope-like structures of densely packed carbon fibers. Such structures can be assembled from carbon yarns, for example. Braided structures can include a hollow portion or a braided structure can be assembled about another core material.

In some embodiments a number of primary carbon fiber material structures can be organized into fabric or sheet-like structures. These include, for example, woven carbon fabrics, non-woven carbon fiber mat and carbon fiber ply, in addition to the tapes described above. Such higher ordered structures can be assembled from parent tows, yarns, filaments or the like, with CNTs already infused in the parent fiber. Alternatively such structures can serve as the substrate for the CNT infusion processes described herein.

There are three types of carbon fiber which are categorized based on the precursors used to generate the fibers, any of which can be used in the invention: Rayon, Polyacrylonitrile (PAN) and Pitch. Carbon fiber from rayon precursors, which are cellulosic materials, has relatively low carbon content at about 20% and the fibers tend to have low strength and stiffness. Polyacrylonitrile (PAN) precursors provide a carbon fiber with a carbon content of about 55%. Carbon fiber based on a PAN precursor generally has a higher tensile strength than carbon fiber based on other carbon fiber precursors due to a minimum of surface defects.

Pitch precursors based on petroleum asphalt, coal tar, and polyvinyl chloride can also be used to produce carbon fiber. Although low cost pitches may be available and high in carbon yield, there can be issues of non-uniformity in a given batch.

CNTs useful for infusion to carbon fiber materials include single-walled CNTs, double-walled CNTs, multi-walled CNTs, and mixtures thereof. The exact CNTs to be used depends on the application of the CNT-infused carbon fiber. CNTs can be used for thermal and/or electrical conductivity applications, or as insulators. In some embodiments, the infused carbon nanotubes are single-wall nanotubes. In some embodiments, the infused carbon nanotubes are multi-wall nanotubes. In some embodiments, the infused carbon nanotubes are a combination of single-wall and multi-wall nanotubes. There are some differences in the characteristic properties of single-wall and multi-wall nanotubes that, for some end uses of the fiber, dictate the synthesis of one or the other type of nanotube. For example, single-walled nanotubes can be semi-conducting or metallic, while multi-walled nanotubes are metallic.

CNTs lend their characteristic properties such as mechanical strength, low to moderate electrical resistivity, high thermal conductivity, and the like to the CNT-infused carbon fiber material. For example, in some embodiments, the electrical resistivity of a carbon nanotube-infused carbon fiber material is lower than the electrical resistivity of a parent carbon fiber material. More generally, the extent to which the resulting CNT-infused fiber expresses these characteristics can be a function of the extent and density of coverage of the carbon fiber by the carbon nanotubes. Any amount of the fiber surface area, from 0-55% of the fiber can be covered assuming an 8 nm diameter, 5-walled MWNT (again this calculation counts the space inside the CNTs as fillable). This number is lower for smaller diameter CNTs and higher for greater diameter CNTs. 55% surface area coverage is equivalent to about 15,000 CNTs/micron. Further CNT properties can be imparted to the carbon fiber material in a manner dependent on CNT length, as described above. Infused CNTs can vary in length ranging from between about 1 micron to about 500 microns, including 1 micron, 2 microns, 3 microns, 4 micron, 5, microns, 6, microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, 150 microns, 200 microns, 250 microns, 300 microns, 350 microns, 400 microns, 450 microns, 500 microns, and all values in between. CNTs can also be less than about 1 micron in length, including about 0.5 microns, for example. CNTs can also be greater than 500 microns, including for example, 510 microns, 520 microns, 550 microns, 600 microns, 700 microns and all values in between.

Compositions of the invention can incorporate CNTs have a length from about 1 micron to about 10 microns. Such CNT lengths can be useful in application to increase shear strength. CNTs can also have a length from about 5 to about 70 microns. Such CNT lengths can be useful in applications for increased tensile strength if the CNTs are aligned in the fiber direction. CNTs can also have a length from about 10 microns to about 100 microns. Such CNT lengths can be useful to increase electrical/thermal properties as well as mechanical properties. The process used in the invention can also provide CNTs having a length from about 100 microns to about 500 microns, which can also be beneficial to increase electrical and thermal properties. Such control of CNT length is readily achieved through modulation of carbon feedstock and inert gas flow rates coupled with varying linespeeds and growth temperature.

In some embodiments, compositions that include spoolable lengths of CNT-infused carbon fiber materials can have various uniform regions with different lengths of CNTs. For example, it can be desirable to have a first portion of CNT-infused carbon fiber material with uniformly shorter CNT lengths to enhance shear strength properties, and a second portion of the same spoolable material with a uniform longer CNT length to enhance electrical or thermal properties.

Processes of the invention for CNT infusion to carbon fiber materials allow control of the CNT lengths with uniformity and in a continuous process allowing spoolable carbon fiber materials to be functionalized with CNTs at high rates. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time of about 5 to about 30 seconds can produce CNTs having a length between about 1 micron to about 10 microns. In some embodiments, a material residence time of about 30 to about 180 seconds can produce CNTs having a length between about 10 microns to about 100 microns. In still further embodiments, a material residence time of about 180 to about 300 seconds can produce CNTs having a length between about 100 microns to about 500 microns. One skilled in the art will recognize that these ranges are approximate and that CNT length can also be modulated by reaction temperatures, and carrier and carbon feedstock concentrations and flow rates.

CNT-infused carbon fiber materials of the invention include a barrier coating. Barrier coatings can include for example an alkoxysilane, methylsiloxane, an alumoxane, alumina nanoparticles, spin on glass and glass nanoparticles. As described below, the CNT-forming catalyst can be added to the uncured barrier coating material and then applied to the carbon fiber material together. In other embodiments the barrier coating material can be added to the carbon fiber material prior to deposition of the CNT-forming catalyst. The barrier coating material can be of a thickness sufficiently thin to allow exposure of the CNT-forming catalyst to the carbon feedstock for subsequent CVD growth. In some embodiments, the thickness is less than or about equal to the effective diameter of the CNT-forming catalyst. In some embodiments, the thickness of the barrier coating is in a range from between about 10 nm to about 100 nm. The barrier coating can also be less than 10 nm, including 1 nm, 2 nm, 3 nm, 4 nm, 5 nm, 6 nm, 7 nm, 8 nm, 9 nm, 10 nm, and any value in between.

Without being bound by theory, the barrier coating can serve as an intermediate layer between the carbon fiber material and the CNTs and serves to mechanically infuse the CNTs to the carbon fiber material. Such mechanical infusion still provides a robust system in which the carbon fiber material serves as a platform for organizing the CNTs while still imparting properties of the CNTs to the carbon fiber material. Moreover, the benefit of including a barrier coating is the immediate protection it provides the carbon fiber material from chemical damage due to exposure to moisture and/or any thermal damage due to heating of the carbon fiber material at the temperatures used to promote CNT growth.

The infused CNTs disclosed herein can effectively function as a replacement for conventional carbon fiber “sizing.” The infused CNTs are more robust than conventional sizing materials and can improve the fiber-to-matrix interface in composite materials and, more generally, improve fiber-to-fiber interfaces. Indeed, the CNT-infused carbon fiber materials disclosed herein are themselves composite materials in the sense the CNT-infused carbon fiber material properties will be a combination of those of the carbon fiber material as well as those of the infused CNTs. Consequently, embodiments of the present invention provide a means to impart desired properties to a carbon fiber material that otherwise lack such properties or possesses them in insufficient measure. Carbon fiber materials can be tailored or engineered to meet the requirements of specific applications. The CNTs acting as sizing can protect carbon fiber materials from absorbing moisture due to the hydrophobic CNT structure. Moreover, hydrophobic matrix materials, as further exemplified below, interact well with hydrophobic CNTs to provide improved fiber to matrix interactions.

In some embodiments the present invention provides a continuous process for CNT infusion that includes (a) disposing a carbon nanotube-forming catalyst on a surface of a carbon fiber material of spoolable dimensions; and (b) synthesizing carbon nanotubes directly on the carbon fiber material, thereby forming a carbon nanotube-infused carbon fiber material. For a 9 foot long system, the linespeed of the process can range from between about 1.5 ft/min to about 108 ft/min. The linespeeds achieved by the process described herein allow the formation of commercially relevant quantities of CNT-infused carbon fiber materials with short production times. For example, at 36 ft/min linespeed, the quantities of CNT-infused carbon fibers (over 5% infused CNTs on fiber by weight) can exceed over 100 pound or more of material produced per day in a system that is designed to simultaneously process 5 separate tows (20 lb/tow). Systems can be made to produce more tows at once or at faster speeds by repeating growth zones. Moreover, some steps in the fabrication of CNTs, as known in the art, have prohibitively slow rates preventing a continuous mode of operation. For example, in a typical process known in the art, a CNT-forming catalyst reduction step can take 1-12 hours to perform. CNT growth itself can also be time consuming, for example requiring tens of minutes for CNT growth, precluding the rapid linespeeds realized in the present invention. The process described herein overcomes such rate limiting steps.

The CNT-infused carbon fiber material-forming processes of the invention can avoid high degrees CNT entanglement that occurs when trying to apply suspensions of pre-formed carbon nanotubes to fiber materials. That is, because pre-formed CNTs are not fused to the carbon fiber material, the CNTs tend to bundle and entangle. The result is a poorly uniform distribution of CNTs that weakly adhere to the carbon fiber material. However, processes of the present invention can provide, if desired, a highly uniform entangled CNT mat on the surface of the carbon fiber material by reducing the growth density. The CNTs grown at low density are infused in the carbon fiber material first. In such embodiments, the fibers do not grow dense enough to induce vertical alignment, the result is entangled mats on the carbon fiber material surfaces. By contrast, manual application of pre-formed CNTs does not insure uniform distribution and density of a CNT mat on the carbon fiber material.

To infuse carbon nanotubes into a carbon fiber material, the carbon nanotubes are synthesized on the carbon fiber material which is conformally coated with a barrier coating. In one embodiment, this is accomplished by first conformally coating the carbon fiber material with a barrier coating and then disposing nanotube-forming catalyst on the barrier coating. In some embodiments, the barrier coating can be partially cured prior to catalyst deposition. This can provide a surface that is receptive to receiving the catalyst and allowing it to embed in the barrier coating, including allowing surface contact between the CNT forming catalyst and the carbon fiber material. In such embodiments, the barrier coating can be fully cured after embedding the catalyst. In some embodiments, the barrier coating is conformally coated over the carbon fiber material simultaneously with deposition of the CNT-form catalyst. Once the CNT-forming catalyst and barrier coating are in place, the barrier coating can be fully cured.

In some embodiments, the barrier coating can be fully cured prior to catalyst deposition. In such embodiments, a fully cured barrier-coated carbon fiber material can be treated with a plasma to prepare the surface to accept the catalyst. For example, a plasma treated carbon fiber material having a cured barrier coating can provide a roughened surface in which the CNT-forming catalyst can be deposited. The plasma process for “roughing” the surface of the barrier thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, nitrogen, and hydrogen. In some embodiments, plasma roughing can also be performed directly in the carbon fiber material itself. This can facilitate adhesion of the barrier coating to the carbon fiber material.

As described further below the catalyst can be prepared as a liquid solution that contains CNT-forming catalyst that comprise transition metal nanoparticles. The diameters of the synthesized nanotubes are related to the size of the metal particles as described above. In some embodiments, commercial dispersions of CNT-forming transition metal nanoparticle catalyst are available and are used without dilution, in other embodiments commercial dispersions of catalyst can be diluted. Whether to dilute such solutions can depend on the desired density and length of CNT to be grown as described above.

Carbon nanotube synthesis can be based on a chemical vapor deposition (CVD) process and occurs at elevated temperatures. The specific temperature is a function of catalyst choice, but will typically be in a range of about 500 to 1000° C. This operation involves heating the barrier-coated carbon fiber material to a temperature in the aforementioned range to support carbon nanotube synthesis.

CVD-promoted nanotube growth on the catalyst-laden carbon fiber material is then performed. The CVD process can be promoted by, for example, a carbon-containing feedstock gas such as acetylene, ethylene, and/or ethanol. The CNT synthesis processes generally use an inert gas (nitrogen, argon, helium) as a primary carrier gas. The carbon feedstock is provided in a range from between about 0% to about 15% of the total mixture. A substantially inert environment for CVD growth is prepared by removal of moisture and oxygen from the growth chamber.

In the CNT synthesis process, CNTs grow at the sites of a CNT-forming transition metal nanoparticle catalyst. The presence of the strong plasma-creating electric field can be optionally employed to affect nanotube growth. That is, the growth tends to follow the direction of the electric field. By properly adjusting the geometry of the plasma spray and electric field, vertically-aligned CNTs (i.e., perpendicular to the carbon fiber material) can be synthesized. Under certain conditions, even in the absence of a plasma, closely-spaced nanotubes will maintain a vertical growth direction resulting in a dense array of CNTs resembling a carpet or forest. The presence of the barrier coating can also influence the directionality of CNT growth.

The operation of disposing a catalyst on the carbon fiber material can be accomplished by spraying or dip coating a solution or by gas phase deposition via, for example, a plasma process. The choice of techniques can be coordinated with the mode with which the barrier coating is applied. Thus, in some embodiments, after forming a solution of a catalyst in a solvent, catalyst can be applied by spraying or dip coating the barrier coated carbon fiber material with the solution, or combinations of spraying and dip coating. Either technique, used alone or in combination, can be employed once, twice, thrice, four times, up to any number of times to provide a carbon fiber material that is sufficiently uniformly coated with CNT-forming catalyst. When dip coating is employed, for example, a carbon fiber material can be placed in a first dip bath for a first residence time in the first dip bath. When employing a second dip bath, the carbon fiber material can be placed in the second dip bath for a second residence time. For example, carbon fiber materials can be subjected to a solution of CNT-forming catalyst for between about 3 seconds to about 90 seconds depending on the dip configuration and linespeed. Employing spraying or dip coating processes, a carbon fiber material with a surface density of catalyst of less than about 5% surface coverage to as high as about 80% coverage, in which the CNT-forming catalyst nanoparticles are nearly monolayer. In some embodiments, the process of coating the CNT-forming catalyst on the carbon fiber material should produce no more than a monolayer. For example, CNT growth on a stack of CNT-forming catalyst can erode the degree of infusion of the CNT to the carbon fiber material. In other embodiments, the transition metal catalyst can be deposited on the carbon fiber material using evaporation techniques, electrolytic deposition techniques, and other processes known to those skilled in the art, such as addition of the transition metal catalyst to a plasma feedstock gas as a metal organic, metal salt or other composition promoting gas phase transport.

Because processes of the invention are designed to be continuous, a spoolable carbon fiber material can be dip-coated in a series of baths where dip coating baths are spatially separated. In a continuous process in which nascent carbon fibers are being generated de novo, dip bath or spraying of CNT-forming catalyst can be the first step after applying and curing or partially curing a barrier coating to the carbon fiber material. Application of the barrier coating and a CNT-forming catalyst can be performed in lieu of application of a sizing, for newly formed carbon fiber materials. In other embodiments, the CNT-forming catalyst can be applied to newly formed carbon fibers in the presence of other sizing agents after barrier coating. Such simultaneous application of CNT-forming catalyst and other sizing agents can still provide the CNT-forming catalyst in surface contact with the barrier coating of the carbon fiber material to insure CNT infusion.

The catalyst solution employed can be a transition metal nanoparticle which can be any d-block transition metal as described above. In addition, the nanoparticles can include alloys and non-alloy mixtures of d-block metals in elemental form or in salt form, and mixtures thereof. Such salt forms include, without limitation, oxides, carbides, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the carbon fiber by applying or infusing a CNT-forming catalyst directly to the carbon fiber material simultaneously with barrier coating deposition. Many of these transition metal catalysts are readily commercially available from a variety of suppliers, including, for example, Ferrotec Corporation (Bedford, N.H.).

Catalyst solutions used for applying the CNT-forming catalyst to the carbon fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent. Such concentrations can be used when the barrier coating and CNT-forming catalyst is applied simultaneously as well.

In some embodiments heating of the carbon fiber material can be at a temperature that is between about 500° C. and 1000° C. to synthesize carbon nanotubes after deposition of the CNT-forming catalyst. Heating at these temperatures can be performed prior to or substantially simultaneously with introduction of a carbon feedstock for CNT growth.

In some embodiments, the present invention provides a process that includes removing sizing agents from a carbon fiber material, applying a barrier coating conformally over the carbon fiber material, applying a CNT-forming catalyst to the carbon fiber material, heating the carbon fiber material to at least 500° C., and synthesizing carbon nanotubes on the carbon fiber material. In some embodiments, operations of the CNT-infusion process include removing sizing from a carbon fiber material, applying a barrier coating to the carbon fiber material, applying a CNT-forming catalyst to the carbon fiber, heating the fiber to CNT-synthesis temperature and CVD-promoted CNT growth the catalyst-laden carbon fiber material. Thus, where commercial carbon fiber materials are employed, processes for constructing CNT-infused carbon fibers can include a discrete step of removing sizing from the carbon fiber material before disposing barrier coating and the catalyst on the carbon fiber material.

The step of synthesizing carbon nanotubes can include numerous techniques for forming carbon nanotubes, including those disclosed in co-pending U.S. Patent Application No. US 2004/0245088 which is incorporated herein by reference. The CNTs grown on fibers of the present invention can be accomplished by techniques known in the art including, without limitation, micro-cavity, thermal or plasma-enhanced CVD techniques, laser ablation, arc discharge, and high pressure carbon monoxide (HiPCO). During CVD, in particular, a barrier coated carbon fiber material with CNT-forming catalyst disposed thereon, can be used directly. In some embodiments, any conventional sizing agents can be removed prior CNT synthesis. In some embodiments, acetylene gas is ionized to create a jet of cold carbon plasma for CNT synthesis. The plasma is directed toward the catalyst-bearing carbon fiber material. Thus, in some embodiments synthesizing CNTs on a carbon fiber material includes (a) forming a carbon plasma; and (b) directing the carbon plasma onto the catalyst disposed on the carbon fiber material. The diameters of the CNTs that are grown are dictated by the size of the CNT-forming catalyst as described above. In some embodiments, the sized fiber substrate is heated to between about 550 to about 800° C. to facilitate CNT synthesis. To initiate the growth of CNTs, two gases are bled into the reactor: a process gas such as argon, helium, or nitrogen, and a carbon-containing gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor vertically aligned carbon nanotubes can be grown radially about a cylindrical fiber. In some embodiments, a plasma is not required for radial growth about the fiber. For carbon fiber materials that have distinct sides such as tapes, mats, fabrics, plies, and the like, catalyst can be disposed on one or both sides and correspondingly, CNTs can be grown on one or both sides as well.

As described above, CNT-synthesis is performed at a rate sufficient to provide a continuous process for functionalizing spoolable carbon fiber materials. Numerous apparatus configurations facilitate such continuous synthesis as exemplified below.

Another configuration for continuous carbon nanotube synthesis involves a special rectangular reactor for the synthesis and growth of carbon nanotubes directly on carbon fiber materials. The reactor can be designed for use in a continuous in-line process for producing carbon-nanotube bearing fibers. In some embodiments, CNTs are grown via a chemical vapor deposition (“CVD”) process at atmospheric pressure and at elevated temperature in the range of about 550° C. to about 800° C. in a multi-zone reactor. The fact that the synthesis occurs at atmospheric pressure is one factor that facilitates the incorporation of the reactor into a continuous processing line for CNT-on-fiber synthesis. Another advantage consistent with in-line continuous processing using such a zone reactor is that CNT growth occurs in a seconds, as opposed to minutes (or longer) as in other procedures and apparatus configurations typical in the art.

CNT synthesis reactors in accordance with the various embodiments include the following features:

Rectangular Configured Synthesis Reactors: The cross section of a typical CNT synthesis reactor known in the art is circular. There are a number of reasons for this including, for example, historical reasons (cylindrical reactors are often used in laboratories) and convenience (flow dynamics are easy to model in cylindrical reactors, heater systems readily accept circular tubes (quartz, etc.), and ease of manufacturing. Departing from the cylindrical convention, the present invention provides a CNT synthesis reactor having a rectangular cross section. The reasons for the departure are as follows: 1. Since many carbon fiber materials that can be processed by the reactor are relatively planar such as flat tape or sheet-like in form, a circular cross section is an inefficient use of the reactor volume. This inefficiency results in several drawbacks for cylindrical CNT synthesis reactors including, for example, a) maintaining a sufficient system purge; increased reactor volume requires increased gas flow rates to maintain the same level of gas purge. This results in a system that is inefficient for high volume production of CNTs in an open environment; b) increased carbon feedstock gas flow; the relative increase in inert gas flow, as per a) above, requires increased carbon feedstock gas flows. Consider that the volume of a 12K carbon fiber tow is 2000 times less than the total volume of a synthesis reactor having a rectangular cross section. In an equivalent growth cylindrical reactor (i.e., a cylindrical reactor that has a width that accommodates the same planarized carbon fiber material as the rectangular cross-section reactor), the volume of the carbon fiber material is 17,500 times less than the volume of the chamber.

Although gas deposition processes, such as CVD, are typically governed by pressure and temperature alone, volume has a significant impact on the efficiency of deposition. With a rectangular reactor there is a still excess volume. This excess volume facilitates unwanted reactions; yet a cylindrical reactor has about eight times that volume. Due to this greater opportunity for competing reactions to occur, the desired reactions effectively occur more slowly in a cylindrical reactor chamber. Such a slow down in CNT growth, is problematic for the development of a continuous process. One benefit of a rectangular reactor configuration is that the reactor volume can be decreased by using a small height for the rectangular chamber to make this volume ratio better and reactions more efficient. In some embodiments of the present invention, the total volume of a rectangular synthesis reactor is no more than about 3000 times greater than the total volume of a carbon fiber material being passed through the synthesis reactor. In some further embodiments, the total volume of the rectangular synthesis reactor is no more than about 4000 times greater than the total volume of the carbon fiber material being passed through the synthesis reactor. In some still further embodiments, the total volume of the rectangular synthesis reactor is less than about 10,000 times greater than the total volume of the carbon fiber material being passed through the synthesis reactor. Additionally, it is notable that when using a cylindrical reactor, more carbon feedstock gas is required to provide the same flow percent as compared to reactors having a rectangular cross section. It should be appreciated that in some other embodiments, the synthesis reactor has a cross section that is described by polygonal forms that are not rectangular, but are relatively similar thereto and provide a similar reduction in reactor volume relative to a reactor having a circular cross section; c) problematic temperature distribution; when a relatively small-diameter reactor is used, the temperature gradient from the center of the chamber to the walls thereof is minimal. But with increased size, such as would be used for commercial-scale production, the temperature gradient increases. Such temperature gradients result in product quality variations across a carbon fiber material substrate (i.e., product quality varies as a function of radial position). This problem is substantially avoided when using a reactor having a rectangular cross section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided. 2. Gas introduction: Because tubular furnaces are normally employed in the art, typical CNT synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the rectangular CNT reactors.

Zoning. Chambers that provide a relatively cool purge zone depend from both ends of the rectangular synthesis reactor. Applicants have determined that if hot gas were to mix with the external environment (i.e., outside of the reactor), there would be an increase in degradation of the carbon fiber material. The cool purge zones provide a buffer between the internal system and external environments. Typical CNT synthesis reactor configurations known in the art typically require that the substrate is carefully (and slowly) cooled. The cool purge zone at the exit of the present rectangular CNT growth reactor achieves the cooling in a short period of time, as required for the continuous in-line processing.

Non-contact, hot-walled, metallic reactor. In some embodiments, a hot-walled reactor is made of metal is employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation.

However, it has been observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system—especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produced a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot created blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and CNT Synthesis. In the CNT synthesis reactor disclosed herein, both catalyst reduction and CNT growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present invention due, at least in part, to the fact that carbon feedstock gas is introduced at the center of the reactor, not the end as would be typical in the art using cylindrical reactors. The reduction process occurs as the fibers enter the heated zone; by this point, the gas has had time to react with the walls and cool off prior to reacting with the catalyst and causing the oxidation reduction (via hydrogen interactions). It is this transition region where the reduction occurs. At the hottest isothermal zone in the system, the CNT growth occurs, with the greatest growth rate occurring proximal to the gas inlets near the center of the reactor.

In some embodiments, when loosely affiliated carbon fiber materials, such as carbon tow are employed, the continuous process can include steps that spreads out the strands and/or filaments of the tow. Thus, as a tow is unspooled it can be spread using a vacuum-based fiber spreading system, for example. When employing sized carbon fibers, which can be relatively stiff, additional heating can be employed in order to “soften” the tow to facilitate fiber spreading. The spread fibers which comprise individual filaments can be spread apart sufficiently to expose an entire surface area of the filaments, thus allowing the tow to more efficiently react in subsequent process steps. Such spreading can approach between about 4 inches to about 6 inches across for a 3 k tow. The spread carbon tow can pass through a surface treatment step that is composed of a plasma system as described above. After a barrier coating is applied and roughened, spread fibers then can pass through a CNT-forming catalyst dip bath. The result is fibers of the carbon tow that have catalyst particles distributed radially on their surface. The catalyzed-laden fibers of the tow then enter an appropriate CNT growth chamber, such as the rectangular chamber described above, where a flow through atmospheric pressure CVD or PE-CVD process is used to synthesize the CNTs at rates as high as several microns per second. The fibers of the tow, now with radially aligned CNTs, exit the CNT growth reactor.

In some embodiments, CNT-infused carbon fiber materials can pass through yet another treatment process that, in some embodiments is a plasma process used to functionalize the CNTs. Additional functionalization of CNTs can be used to promote their adhesion to particular resins. Thus, in some embodiments, the present invention provides CNT-infused carbon fiber materials having functionalized CNTs.

As part of the continuous processing of spoolable carbon fiber materials, the a CNT-infused carbon fiber material can further pass through a sizing dip bath to apply any additional sizing agents which can be beneficial in a final product. Finally if wet winding is desired, the CNT-infused carbon fiber materials can be passed through a resin bath and wound on a mandrel or spool. The resulting carbon fiber material/resin combination locks the CNTs on the carbon fiber material allowing for easier handling and composite fabrication. In some embodiments, CNT infusion is used to provide improved filament winding. Thus, CNTs formed on carbon fibers such as carbon tow, are passed through a resin bath to produce resin-impregnated, CNT-infused carbon tow. After resin impregnation, the carbon tow can be positioned on the surface of a rotating mandrel by a delivery head. The tow can then be wound onto the mandrel in a precise geometric pattern in known fashion.

The winding process described above provides pipes, tubes, or other forms as are characteristically produced via a male mold. But the forms made from the winding process disclosed herein differ from those produced via conventional filament winding processes.

Specifically, in the process disclosed herein, the forms are made from composite materials that include CNT-infused tow. Such forms will therefore benefit from enhanced strength and the like, as provided by the CNT-infused tow.

In some embodiments, a continuous process for infusion of CNTs on spoolable carbon fiber materials can achieve a linespeed between about 0.5 ft/min to about 36 ft/min. In this embodiment where the CNT growth chamber is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length. For example, a flow rate consisting of less than 1% carbon feedstock in inert gas at high linespeeds (6 ft/min to 36 ft/min) will result in CNTs having a length between 1 micron to about 5 microns. A flow rate consisting of more than 1% carbon feedstock in inert gas at high linespeeds (6 ft/min to 36 ft/min) will result in CNTs having length between 5 microns to about 10 microns.

In some embodiments, more than one carbon material can be run simultaneously through the process. For example, multiple tapes tows, filaments, strand and the like can be run through the process in parallel. Thus, any number of pre-fabricated spools of carbon fiber material can be run in parallel through the process and re-spooled at the end of the process. The number of spooled carbon fiber materials that can be run in parallel can include one, two, three, four, five, six, up to any number that can be accommodated by the width of the CNT-growth reaction chamber. Moreover, when multiple carbon fiber materials are run through the process, the number of collection spools can be less than the number of spools at the start of the process. In such embodiments, carbon strands, tows, or the like can be sent through a further process of combining such carbon fiber materials into higher ordered carbon fiber materials such as woven fabrics or the like. The continuous process can also incorporate a post processing chopper that facilitates the formation CNT-infused chopped fiber mats, for example.

In some embodiments, processes of the invention allow for synthesizing a first amount of a first type of carbon nanotube on the carbon fiber material, in which the first type of carbon nanotube is selected to alter at least one first property of the carbon fiber material. Subsequently, process of the invention allow for synthesizing a second amount of a second type of carbon nanotube on the carbon fiber material, in which the second type of carbon nanotube is selected to alter at least one second property of the carbon fiber material.

In some embodiments, the first amount and second amount of CNTs are different. This can be accompanied by a change in the CNT type or not. Thus, varying the density of CNTs can be used to alter the properties of the original carbon fiber material, even if the CNT type remains unchanged. CNT type can include CNT length and the number of walls, for example. In some embodiments the first amount and the second amount are the same. If different properties are desirable in this case along the two different stretches of the spoolable material, then the CNT type can be changed, such as the CNT length. For example, longer CNTs can be useful in electrical/thermal applications, while shorter CNTs can be useful in mechanical strengthening applications.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet.

The CNT-infused carbon fiber materials can benefit from the presence of CNTs not only in the properties described above, but can also provide lighter materials in the process. Thus, such lower density and higher strength materials translates to greater strength to weight ratio.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other processes, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. An electrode comprising:
a substrate having a carbon nanostructure (CNS) disposed thereon; and
a coating comprising an active material conformally disposed about the carbon nanostructure and substrate.

2. The electrode of claim 1, wherein the substrate comprises one selected from the group consisting of glass, carbon, ceramic, metal, and an organic polymer.

3. The electrode of claim 1, wherein the substrate comprises a form selected from the group consisting of a fiber, a tow, a woven or non-woven fabric, a foil, a ply, a chopped strand mat, and a felt.

4. The electrode of claim 1, wherein the substrate comprises a carbon fiber.

5. The electrode of claim 1, wherein the substrate comprises a carbon fabric.

6. The electrode of claim 1, wherein the active material comprises one selected from the group consisting of a metal oxide, a metal phosphate, a conducting polymer, and a semiconductor.

7. The electrode of claim 6, wherein the active material comprises one selected from the group consisting of lithium oxide, lithium phosphate, oxides of manganese, oxides of ruthenium, polypyrrole, and silicon.

8. A hybrid capacitor-battery comprising:
an electrode comprising:
a substrate having a carbon nanostructure (CNS) disposed thereon; and
an optional coating comprising an active material conformally disposed about the carbon nanostructure and substrate; and
a bifunctional electrolyte, wherein the bifunctional electrolyte is capable of energy storage.

9. The hybrid capacitor-battery of claim 8, wherein the substrate comprises one selected from the group consisting of glass, carbon, ceramic, metal, and an organic polymer.

10. The hybrid capacitor-battery of claim 8, wherein the substrate comprises a form selected from the group consisting of a fiber, a tow, a woven or non-woven fabric, a foil, a ply, a chopped strand mat, and a felt.

11. The hybrid capacitor-battery of claim 8, wherein the substrate comprises a carbon fiber.

12. The hybrid capacitor-battery of claim 8, wherein the substrate comprises a carbon fabric.

13. The hybrid capacitor-battery of claim 8, wherein the active material comprises one selected from the group consisting of a metal oxide, a metal phosphate, a conducting polymer, and a semiconductor.

14. The hybrid capacitor-battery of claim 13, wherein the active material comprises one selected from the group consisting of lithium oxide, lithium phosphate, oxides of manganese, oxides of ruthenium, polypyrrole, and silicon.

15. The hybrid capacitor-battery of claim 8, wherein the optional coating is present and the bifunctional electrolyte comprises vanadium ions.

16. The hybrid capacitor-battery of claim 8, wherein the optional coating is not present and the bifunctional electrolyte comprises an organic electrolyte.

17. A method comprising:
synthesizing a carbon nanostructure (CNS) on a substrate to provide a CNS-laden substrate; and
conformally coating the CNS-laden substrate with an active material.

18. The method of claim 17, wherein the coating step comprises one selected from the group consisting of chemical vapor deposition, physical vapor deposition, electrochemical deposition, solution dipping, and solution spraying.

19. The method of claim 17, wherein the substrate comprises a form selected from the group consisting of a fiber, a tow, a woven or non-woven fabric, a foil, a ply, a chopped strand mat, and a felt.

20. The method of claim 17, wherein the active material comprises one selected from the group consisting of lithium oxide, lithium phosphate, oxides of manganese, oxides of ruthenium, polypyrrole, and silicon.
